(19) United States
(12) Patent Application Publication
(10) Pub. No.: US 2008/0011233 A1
(43) Pub. Date: Jan. 17, 2008

(54) Installation for automatically milking an animal

(75) Inventor: Karel Van Den Berg, Bleskensgraaf (NL)

Correspondence Address: HOWREY LLP, C/O IP DOCKETING DEPARTMENT, 2941 FAIRVIEW PARK DR., SUITE 200, FALLS CHURCH, VA, 22042, US

(73) Assignee: MAASLAND N.V.

(21) Appl. No.: 11/822,666

(22) Filed: Jul. 9, 2007

(30) Foreign Application Priority Data
Jul. 12, 2006 (NL) 1032150

(51) Int. Cl. A01J 5/017

(52) U.S. Cl. 119/14.08; 119/14.11; 119/14.14

(57) ABSTRACT

An installation for automatically milking an animal is provided with a box for containing an animal to be milked and with a robot arm for automatically connecting teat cups to the teats of the animal. The installation also includes an animal recognition device for supplying an animal recognition signal representative of the identity of the animal, a computer with a memory and an input device for inputting animal data relating to the animal into the memory. The animal recognition signal is automatically linkable in the memory with the animal data by operating the input device.

### CROSS REFERENCE TO RELATED APPLICATIONS

This application claims priority from Dutch patent application 1032150 filed on 12 Jul. 2006, the contents of which are hereby incorporated by reference in their entirety.

### BACKGROUND OF THE INVENTION

1. Field of the Invention

The invention relates to installations for automatically milking animals and more particularly to the type of installation-comprising a device for automatically recognising an animal presenting itself for milking wherein a treatment may be carried out upon the animal. The invention further relates to methods of performing treatment on such animals in a milking installation and to an improved milking box for containing the animal to be milked.

2. Description of the Related Art

Automatic milking installations are known in which animals presenting themselves for milking are automatically identified. In such automatic installations, milking usually takes place without the presence of a human operator. A device is known from U.S. Pat. No. 7,114,458, incorporated herein by reference, in which animal data is stored in a database. Individual animals may be pre-selected to receive treatment. In response to a pre-selected animal arriving at the milking installation, a farmer may be notified and may go to the installation in order to perform the treatment on the animal.

Although prior art devices may provide the possibility of pre-selecting animals and storing data relating to their treatment, the way in which this has been achieved remains open to error. In general, pre-selection requires a farmer or operator to enter data at a computer, often located remotely from the milking installation. In order to enter data, the record for a desired animal is retrieved and the relevant pre-selection or treatment data is assigned to that animal. It may be the case that a farmer injects an animal at the milking installation and later forgets to record the treatment or records it on the record of the wrong animal. As a result of this error, the treatment may not be correctly followed or milk from the wrong animal may be separated for disposal.

Additionally, when treating an animal that has presented itself for milking, it may be necessary for an operator to have improved access to the animal. Automatic milking generally takes place in a milking box in which a robot having a robot arm is located at one longitudinal side of the box. For the animals, access to and exit from the box takes place through gates in the other longitudinal side of the box. The position of the robot arm distinguishes a so-called dirty side from a clean side of the installation. The dirty side is orientated towards the animal accommodation and comprises the entrance and exit for the animal. The robot arm is located at the clean side. The clean side is generally not accessible to the animals and may in fact be virtually a separate room. When an animal is not willing to enter the box voluntarily, it must be led into the box by the operator. In present designs, this requires the operator to pass around to the dirty side of the box and fasten a halter around the animal's head in order to pull the animal by means of the halter into the box via the entrance of the box. The operator leaves the box via the exit of the box at the dirty side. A disadvantage of such an installation is that the operator becomes contaminated when leaving the box by passing through the animal accommodation. In certain circumstances it may also be time consuming or inconvenient for an operator to pass from the area adjacent the robot arm through the animal accommodation to the dirty side of the box.

### BRIEF SUMMARY OF THE INVENTION

According to the invention these drawbacks are at least partially addressed by providing an installation for automatically milking an animal comprising an animal recognition device for supplying an animal recognition signal representative of the identity of an individual animal, a computer having a memory, the memory comprising animal data related to the individual animal and treatment data related to a treatment and an operator actuated input device, arranged on actuation to automatically link the treatment data with the animal data for the individual animal identified by the animal recognition device. By automatically identifying the animal and subsequently linking the treatment data to the animal data for the identified animal in response to operator input, errors may be avoided. There can be no chance that the registered treatment is associated with the record of another animal and the chance of an operator forgetting to register the treatment is reduced since input can take place immediately, on or before treating the animal.

The treatment data preferably comprise data relating to the treatment of the animal with a medicine. This treatment may comprise an injection, oral drench, ointment, treatment of the teats or any other appropriate medication. In this manner it is automatically registered in the animal data that a medicine has been administered. This is particularly practical for controlling authorities in order to be able to trace the origin of a particular contamination in an animal or milk in case of calamities.

In a favourable embodiment, the installation comprises an animal recognition device that is adapted to cooperate with a transponder that is attachable on or to the animal.

In a further preferred embodiment the input device may comprise a push or touch button for linking animal data in the memory by one single action or pushing movement. By a pushing movement is also meant only touching the button. Such an input device is easily operated even with gloved hands. Because only a single action is required, an operator will not be tempted to leave the input of data to another moment. Such a button may be assigned to a single treatment for all animals or may be linked to a particular treatment recommended for the present animal.

It is further advantageous if the installation comprises several push or touch buttons, each push or touch button being suitable for inputting treatment data relating to an associated different treatment. By means of this embodiment it is possible to perform different treatments, each treatment requiring another associated modification of animal data in the memory. The push or touch button may also constitute part of a larger touch screen. Such known screens, controlled by the computers program, may display information or touch buttons according to a user's wishes.

The installation preferably also comprises a separation device for separating milk, the animal data including data by means of which the separation device is controllable. After an animal has been treated with a medicine, the milk obtained is often unfit for human consumption and has to be separated. It is then practical that this can take place automatically.

It is further advantageous if the installation comprises a marker that is capable of being activated by the input device or under the control of the computer. Marked animals can easily be retrieved in the herd. Automatic marking facilitates and accelerates this procedure.

According to another aspect of the present invention, the milking installation comprises a box comprising at a first longitudinal side, a passage opening for giving an operator access from the outside of the box to the inside thereof and vice versa. By making use of the passage opening it is possible for the operator to go directly from the inside of the box to the clean side thereof.

Preferably, the width of the passage opening is between 0.3 m and 0.5 m and the height of the passage opening is between 1.0 m and 1.8 m. Such dimensions are sufficient for a human to easily pass through but prevent passage of a cow. Nevertheless, the passage opening may be closable. This prevents e.g. smaller animals from trying to leave the box via the passage opening or from putting their heads through it.

The passage opening is in particular located in the front half of the box. By front half is meant that half in which, seen in longitudinal direction, the animal's head is located in the milking position. In such a construction it is easily possible for an operator to lead an animal into the box by means of a cord and to leave the box himself at the front side thereof.

According to a further aspect of the present invention, there is provided a method of treating an animal comprising automatically recognizing the animal using an animal recognition device to provide an animal recognition signal representative of the identity of an individual animal, providing a computing device having a memory, the memory comprising animal data related to the individual animal and treatment data related to a treatment for performing on the animal, performing the treatment on the animal and providing a treatment signal, providing the treatment signal and the animal recognition signal to the computing device and automatically associating the treatment data with the animal data for the individual animal identified by the animal recognition device. Performance of the method as described herein can lead to reduction in errors in the assignment of treatment data and greater efficiency of operation.

### BRIEF DESCRIPTION OF THE DRAWINGS

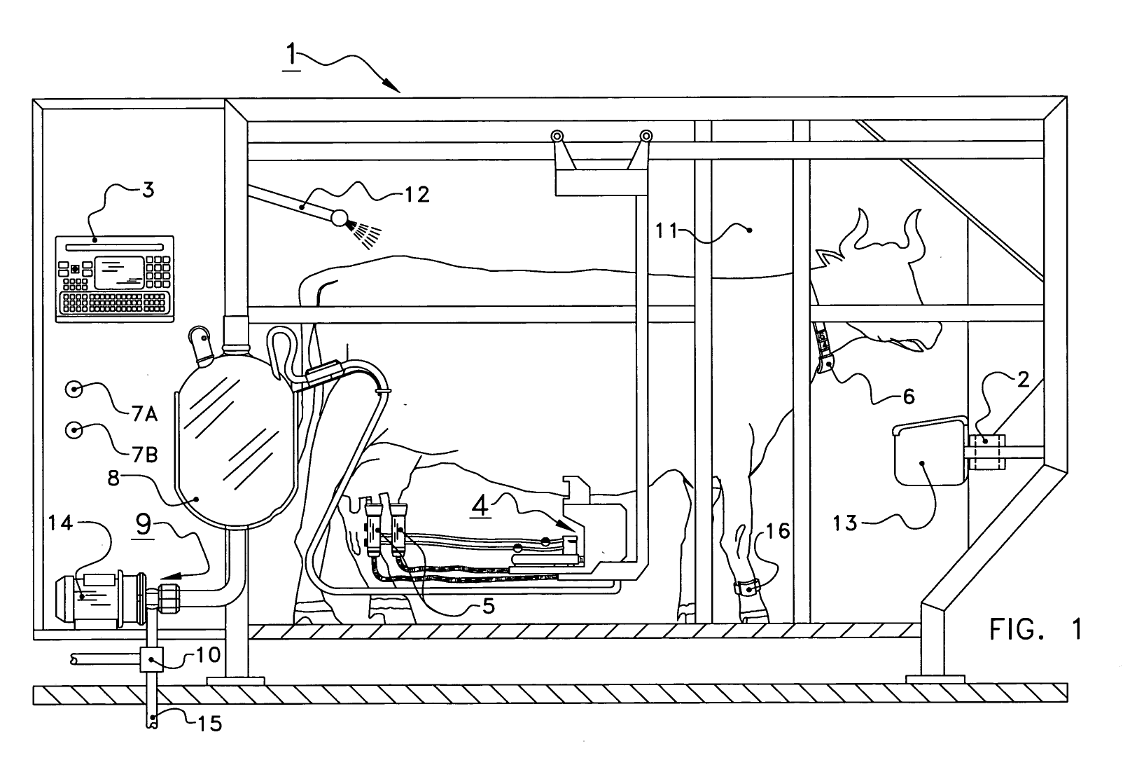

The invention will be explained hereinafter in further detail with reference to an embodiment shown in the drawing, in which FIG. 1 is a side view of the installation according to the invention.

### DESCRIPTION OF ILLUSTRATIVE EMBODIMENTS

FIG. 1 shows an installation for milking an animal with an animal recognition device 2 for supplying an animal recognition signal representative of the identity of the animal, a computer 3 with a memory and an input device for linking to treatment data relating to a particular treatment stored in the memory. By operating the input device, the animal recognition signal is automatically linkable in the memory with the treatment data relating to the treatment of the animal. The animal recognition signal is in the form of an animal number. The installation further comprises a box 1 for containing the animal and a robot arm 4 for automatically connecting teat cups 5 to the teats of the animal located in the box 1. The robot arm 4 is movable in horizontal direction along a rail and is movable from a first longitudinal side of the box 1 to under the animal. Automatic connection of the teat cups 5 by means of the arm takes place in a manner known per se. In order to recognize the animal located in the box 1 the installation comprises an animal recognition device 2 that is capable of cooperating with a transponder 6 around the neck of the animal. The animal recognition device 2 may also be of another type, such as a device recognizing by means of image recognition, an iris scanner or a nose scanner. The input device comprises two push or touch buttons 7A, 7B suitable for inputting animal data relating to two associated different treatments. The installation further comprises a milk collecting vessel 8 in which the milk of one milking run is collected and which also serves for separating air. A separation device 9 for separating milk is disposed at the lower side of the milk collecting vessel 8. The separation device 9 comprises a three-way-valve 10 that is controllable by the computer 3 on the basis of animal data. The computer 3 further controls the different components and the course of the milking process. In order to make it possible to keep the animal in the box 1, the box 1 is provided with bars. These leave sufficient space to make it possible to treat the animal from outside the box 1, for example for giving an injection.

The box 1 comprises at the first longitudinal side a passage opening 11 for giving an operator access from the outside of the box 1 to the inside thereof and vice versa. The passage opening 11 is constituted by two vertical bars and provides sufficient space for an operator, but is too narrow to let pass the animal to be milked. In a non-shown embodiment, the passage opening 11 is closable, for example by a shiftable or pivotable beam. Such a beam prevents the animal from putting its head through the passage opening 11.

The entrance and exit doors for the animal are not shown. These are located at the other longitudinal side of the box 1. At this side there is also located a (non-shown) second passage opening 11. Owing to the fact that there is a passage opening at both longitudinal sides, it is possible for an operator to use the box as a passage to the animal accommodation.

The installation further comprises a marker 12 that is capable of being activated by the input devices 7A, 7B. The marker 12 is designed as a sprayer in order to apply a colorant to the back of the animal. In order to distinguish which treatment has been performed, it is possible to apply several markers 12 with different colours or to spray a particular pattern according to the sort of treatment.

The mode of operation of the invention is as follows. An animal enters the box 1 voluntarily, or is led into the box 1 by an operator, for example by means of a cord around its head. In the latter case, the operator will leave the box 1 at the front side through the passage opening 11.

At the front side of the box 1, near the feed trough 13, there is disposed the animal recognition device 2 that recognizes the animal via the transponder 6 and generates an animal recognition signal. In order to prevent animals located close to the installation from being disturbed by transponders 6, the animal recognition signal is only used by the computer 3 if the entrance and exit door are both completely closed. Furthermore, the animal recognition signal is only used by the computer 3 if during a particular minimum period of time the same identity is registered. If several identities are registered, an alarm will go off.

In the register of the identified animal it is indicated that the animal in question has to undergo a treatment. Subsequently, via the mobile telephone, the computer 3 draws the operator's attention to the fact that the animal in question is present in the box 1. Subsequently, the operator will treat the animal, for example by injecting it with an antibiotic. This takes place from the outside of the box 1 through the bars of the box 1.

In a non-shown embodiment, the installation comprises a medicine reader in the form of a bar code or chip code reader. In this case, the operator holds the packing of the medicine X against the medicine reader, after which the code on the packing is read and passed on to the computer 3. It is also possible that the computer 3 has released itself the medicine X via a so-called medicine chest. Such a chest and its mode of operation are described in patent application WO-A-0036568, the contents of which are incorporated herein by reference in their entirety. In the latter case, the computer 3 assumes that the treatment takes place with the medicine X that has been released by the medicine chest. In a particular embodiment, release of the medicine is only possible if the bar code/chip code reader is activated by a so-called treatment tag 16. Said treatment tag 16 is detachably disposed on a leg of the animal and may be disposed by another person. In this manner it is possible to disconnect diagnosis and treatment from each other and also to make sure that a treatment has taken place. The operator detaches the treatment tag 16, scans it with the bar code or chip code reader, after which the medicine chest releases the allocated medicine.

When the treatment has been performed, the operator presses the push or touch button ‘antibiotics’ 7A. The animal data, i.e. ‘treatment with medicine X’, is now automatically linked with the animal number and stored in the memory of the computer 3. Besides, the point of time of pressing the push or touch button, the identity of the operator, if known, and, in the case of several boxes, the box number, are stored as well. In the memory of the computer 3 ‘treatment with medicine X’ is linked with ‘3-day separation’. The computer 3 will separate from now on the milk obtained from this animal during the next three days. Pressing the push or touch button 7A, 7B has also activated the marker 12 that sprays a colorant on the back. Subsequently, the animal is automatically milked in a known manner. The robot arm 4 detects the teats, connects the teat cups 5 and through the milking vacuum the milk is drawn from the udder and received in the milk collecting vessel 8. After the milking has been finished, the computer 3 activates the separation device 9 on the basis of the action ‘3-day separation’. The three-way-valve 10 is controlled in such a way that the line from the pump 14 to the milk tank is closed and the line to the sewer 15 is open. Subsequently, the computer 3 controls the pump 14 and the milk collecting vessel 8 is emptied by pumping its contents to the sewer 15.

In another non-shown embodiment, the installation comprises a pivotable or rotatable platform on which the animal is located at least during milking. Connection of the teat cups takes place by means of a mobile milking robot. Such a milking robot and such a pivotable platform are described in U.S. Pat. No. 7,231,886 the contents of which are incorporated herein by reference in their entirety. In this case, the input device is provided on the mobile milking robot or on the pivotable platform in the vicinity of the identified animal.

Although the invention has been described in relation to a particular automatic milking device, the skilled man will immediately understand that it is applicable to other installations as described e.g. in U.S. Pat. No. 7,114,458. The invention is furthermore not limited to automatic milking and certain aspects will also be immediately applicable in conventional milking installation in which the animals to be milked are arranged in rows. In such a case, a milking parlour may be considered equivalent to the box 1.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. An installation for automatically milking an animal comprising:
an animal recognition device for supplying an animal recognition signal representative of the identity of an individual animal;
a computer with a memory, the memory comprising animal data related to the individual animal and treatment data related to a treatment; and
an operator actuated input device, arranged on actuation to automatically link the treatment data with the animal data for the individual animal identified by the animal recognition device.

2. The installation as claimed in claim 1, wherein the treatment data comprise data relating to the treatment of the animal with a medicine.

3. The installation as claimed in claim 1, wherein the animal recognition device is responsive to a transponder that is attachable to the animal.

4. The installation as claimed in claim 1, wherein the input device comprises a push or touch button for linking animal data in the memory by a single action.

5. The installation as claimed in claim 1, wherein the installation comprises several push or touch buttons and the memory comprises treatment data relating to a plurality of different treatments, each push or touch button being arranged to link treatment data relating to an associated different treatment with the animal data.

6. The installation as claimed in claim 1, wherein the installation comprises a separation device for separating milk, the separation device being controllable by the treatment data.

7. The installation as claimed in claim 1, wherein the installation comprises a marker that is capable of being activated by the input device.

8. The installation as claimed in claim 1, wherein the installation comprises a pivotable platform on which the animal is located at least during milking.

9. The installation as claimed in claim 1, wherein the installation comprises a robot arm for connecting teat cups to the teats of the animal.

10. The installation as claimed in claim 1, wherein the installation comprises a box for containing the animal to be milked and the input device is located on or adjacent to the box.

11. The installation as claimed in claim 10, wherein the box has a longitudinal side and the input device is located at the longitudinal side at an exterior of the box, the box further comprising a passage opening through the longitudinal side for allowing entry of an operator from the outside of the box to the inside thereof and vice versa;

12. The installation as claimed in claim 11, wherein the width of the passage opening is between 0.3 m and 0.5 m.

13. The installation as claimed in claim 11, wherein the box has a front half and a rear half, a milking device being located at the longitudinal side at the rear half of the box and the passage opening being located in the front half of the box.

14. An installation for automatically milking an animal, comprising:
a box for containing the animal to be milked, the box having a longitudinal side and a passage opening through the longitudinal side for allowing entry of an operator from the outside of the box to the inside thereof and vice versa;
a robot arm for automatically connecting teat cups to the teats of the animal, the robot arm being movable from a position at the longitudinal side of the box to a position under the animal.

15. The installation as claimed in claim 14, wherein the width of the passage opening is between 0.3 m and 0.5 m.

16. The installation as claimed in claim 15, wherein the height of the passage opening is between 1.0 m and 1.8 m.

17. The installation as claimed in claim 14, wherein the passage opening is closable.

18. The installation as claimed in claim 14, wherein the box has a front half and a rear half, the robot arm being located at the rear half of the box and the passage opening being located in the front half of the box.

19. In an installation for automatically milking an animal, a method of treating an animal comprising:
automatically recognizing the animal using an animal recognition device to provide an animal recognition signal representative of the identity of an individual animal;
providing a computing device having a memory, the memory comprising animal data related to the individual animal and treatment data related to a treatment for performing on the animal;
performing the treatment on the animal and providing a treatment signal;
providing the treatment signal and the animal recognition signal to the computing device; and
automatically associating the treatment data with the animal data for the individual animal identified by the animal recognition device.

20. The method as claimed in claim 19, wherein the treatment comprises treatment of the animal with a medicine.

21. The method as claimed in claim 20, wherein the treatment further comprises marking the animal.

22. The method as claimed in claim 19, wherein the installation comprises a separation device for separating milk and the method comprises separating the milk from the treated animal in response to the treatment data being associated with the animal data.

23. The method as claimed in claim 19, wherein the treatment signal is manually provided by an operator at a point of treatment of the animal.
